(19) United States
(12) Patent Application Publication
(10) Pub. No.: US 2005/0260116 A1
(43) Pub. Date: Nov. 24, 2005

(54) Process for producing oxidation-resisting hydrogenated fullerene and hydrogenated fullerene produced by the process

(75) Inventors: Masatoshi Takagi, Yokohama-shi (JP); Jun Enda, Yokohama-shi (JP); Kiminori Kawakami, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: MITSUBISHI CHEMICAL CORPORATION, Tokyo (JP)

(21) Appl. No.: 11/127,321

(22) Filed: May 12, 2005

Related U.S. Application Data
(63) Continuation of application No. PCT/JP03/14992, filed on Nov. 25, 2003.

(30) Foreign Application Priority Data
Nov. 27, 2002 (JP) 2002-344556
Jan. 29, 2003 (JP) 2003-20259

(51) Int. Cl. B82B 1/00

(52) U.S. Cl. 423/445 B

(57) ABSTRACT

A process for purifying a hydrogenated fullerene containing a solvent by heat-treating the hydrogenated fullerene, and a hydrogenated fullerene obtained by the purifying process, which contains the solvent in an amount of not more than 2% by weight based on the weight of the hydrogenated fullerene molecules. Such a hydrogenated fullerene exhibits a high stability in air.

### TECHNICAL FIELD

The present invention relates to a process for producing an oxidation-resisting hydrogenated fullerene exhibiting a high stability in air, and a hydrogenated fullerene having a less solvent content produced by the process.

### BACKGROUND ART

It has been reported that hydrogenated fullerenes are used in application fields of additives for cells, electronic materials or the like (for example, refer to “Perspectives of Fullerene Nanotechnology”, Kluwer Academic Publishers, 2002, p. 357). There are already known various hydrogenated fullerenes having various hydrogen contents from each other, which are obtained by hydrogenation reaction of fullerenes represented by the general formula: Cₙ. In addition, various general production methods have also been reported (for example, refer to “Russian Chemical Reviews”, 1997, Vol. 66, p. 323).

Further, as the specific methods, there have been reported a method of using Zn/hydrochloric acid as a reducing agent in toluene (for example, refer to “Journal of the Chemical Society: Perkin Transaction 2”, 1995, p. 2359), a method of using Li/NH₃ as a reducing agent (for example, refer to “J. Phys. Chem.”, 1990, Vol. 94, p. 8634), a method of using borane as a reducing agent (for example, refer to “Science”, 1993, Vol. 259, p. 1885), a method of reducing fullerenes with H₂ using a catalyst (for example, refer to “Chem. Express”, 1993, Vol. 8, p. 37), a method of hydrogenating with H₂ without using a catalyst (for example, refer to “J. Phys. Chem.”, 1994, Vol. 98, p. 4215), and a method of using dihydroanthracene as a reducing agent (for example, refer to “Angew. Chem. Int. Ed. Engl.”, 1993, Vol. 32, p. 584).

In these conventional literatures, there are described various different methods concerning preservation stability of hydrogenated fullerenes which are synthesized by the respective methods. Therefore, at present, the method of producing stable hydrogenated fullerenes have not necessarily been established until now.

### DISCLOSURE OF THE INVENTION

The present inventors have actually produced the hydrogenated fullerenes by the conventionally known methods to examine properties thereof. As a result, it has been found that these reaction products in the form of a solution or a solvent-containing solid are extremely unstable in air and readily oxidized by oxygen. Therefore, in order to use these hydrogenated fullerenes as suitable industrial materials, it has been demanded to develop the method for handling the hydrogenated fullerenes in a stable state.

As a result of the present inventors' earnest studies for solving the above problems, it has been found that the amount of a solvent contained in the hydrogenated fullerenes has a close relationship with a stability thereof. The present invention has been attained on the basis of the above finding.

To accomplish the aim, in an aspect of the present invention, there is provided a process for producing an oxidation-resisting hydrogenated fullerene, comprising heating a hydrogenated fullerene containing a solvent to remove the solvent therefrom until a solvent content in the hydrogenated fullerene is reduced to not more than 2% by weight. In another aspect of the present invention, there is provided a hydrogenated fullerene containing a solvent in an amount of not more than 2% by weight. In addition, in other aspect of the present invention, there is provided the hydrogenated fullerene for cosmetics as defined in the above.

### BRIEF DESCRIPTION OF THE DRAWINGS

FIG. 1 is a graph showing results of the IR measurement of the hydrogenated fullerene A obtained in Synthesis Example 1.

FIG. 2 is a graph showing results of the TG-DTA measurement of the hydrogenated fullerene A obtained in Synthesis Example 1.

FIG. 3 is a graph showing results of the IR measurement of the oxidation-resisting hydrogenated fullerene obtained in Example 1.

FIG. 4 is a graph showing results of the TG-DTA measurement of the oxidation-resisting hydrogenated fullerene obtained in Example 1.

FIG. 5 is a graph showing results of the IR measurement of the oxidation-resisting hydrogenated fullerene obtained in Example 1 after the elapse of 30 days.

FIG. 6 is a graph showing results of the IR measurement of the hydrogenated fullerene obtained in Comparative Example 1 after the elapse of 30 days.

FIG. 7 is a graph showing results of the TG-DTA measurement of the hydrogenated fullerene obtained in Comparative Example 1 after the elapse of 30 days.

FIG. 8 is a graph showing results of the IR measurement of the hydrogenated fullerene obtained in Comparative Example 2 after the elapse of 40 days.

FIG. 9 is a graph showing results of the IR measurement of the oxidation-resisting hydrogenated fullerene obtained in Example 5.

FIG. 10 is a graph showing results of the IR measurement of the hydrogenated fullerene obtained in Comparative Example 5.

### PREFERRED EMBODIMENT FOR CARRYING OUT THE INVENTION

The present invention is described in detail below.

The solvent-containing hydrogenated fullerene in the present invention means a hydrogenated fullerene into which an organic solvent used in production reaction, post treatments after the reaction or purification treatments is incorporated.

The hydrogenated fullerene is usually produced by subjecting fullerene to hydrogenation reaction. More specifically, the hydrogenated fullerene can be produced by various reduction methods adopted in the above-mentioned conventional techniques. The skeleton of the hydrogenated fullerene obtained by the hydrogenation of fullerene is usually determined depending upon a carbon cluster skeleton of the raw fullerene.

The fullerene as a raw material of the hydrogenated fullerene is a carbon cluster represented by the general formula: Cₙ, wherein n is an integer of not less than 60. Specific examples of the raw fullerene may include C₆₀, (so-called buckminster fullerene), C₇₀, C₇₆, C₇₈, C₈₂, C₈₄, C₉₀, C₉₄, C₉₆ as well as higher-order carbon clusters. In particular, among these raw fullerenes, C₆₀ and C₇₀ are preferred since these fullerenes are industrially available. Therefore, the hydrogenated fullerenes as produced are preferably those having a C₆₀ or C₇₀ skeleton. These raw fullerenes C₆₀ and C₇₀ may be used singly or in the form of a mixture thereof. In the case of the mixture, the mixing ratio between C₆₀ and C₇₀ may be optional, for example, in the range of 1:99 to 99:1.

Examples of reagents usable upon production of the hydrogenated fullerene may include H₂ molecules, metal reducing reagents such as typically Zn/hydrochloric acid and Li/NH₃, hydrogen transfer reagents such as dihydroanthracene and diimides, hydride reagents such as borane, or the like. In the reduction reaction using the H₂ molecules, there may be employed a method using a catalyst such as Ru/C and Ni/Al₂O₃, a method of conducting the reduction reaction under high-temperature and high-pressure conditions without using any catalyst, or the like.

The processes for production of the hydrogenated fullerene are generally classified into a process using a solvent (solvent process) and a process using no solvent (solvent-free process).

As the solvent-free process, there are known a process using dihydroanthracene as a reducing agent, and a process in which the reduction reaction is conducted by the H₂ molecules under high-temperature and high-pressure conditions in the absence of a catalyst, etc.

In the solvent-free process using dihydroanthracene, the reducing agent used therein is expensive, and it may be difficult to remove a large amount of anthracene by-produced. Also, in the solvent-free process by hydrogen-reduction using no catalyst, since the reduction reaction is conducted under high-temperature and high-pressure conditions, special reaction facilities tend to be required therefor. Thus, all of the solvent-free processes tend to be unsuitable for industrial mass-production of the hydrogenated fullerene.

On the other hand, as the solvent process, there may be exemplified a reduction process using Zn/hydrochloric acid, in which fullerene is dissolved in toluene, mixed with zinc powder and concentrated hydrochloric acid, and then stirred at room temperature to produce the hydrogenated fullerene, a reduction process using a hydrogen gas in the presence of a Ni/Al₂O₃ catalyst, in which fullerene is dissolved in toluene, mixed with the Ni/Al₂O₃ catalyst, and then after introducing hydrogen at 5 MPa into an autoclave, heated to 150° C. under stirring to produce the hydrogenated fullerene, or the like. In these processes, after the hydrogenation reaction of fullerene, usually, the catalyst is removed and the solvent is distilled off from the reaction solution, thereby obtaining the aimed hydrogenated fullerene.

The solvent used in the hydrogenation of fullerene may be such a solvent generally used in the reaction and purification thereof. Although the kind of solvent used varies depending upon production method of the hydrogenated fullerene as well as reaction conditions therefor, there may be usually used those solvents having a boiling point of 0 to 250° C. under ordinary pressure. In the hydrogenation reaction of fullerene, there may be used solvents capable of dissolving the raw fullerene. Whereas, in the purification of the hydrogenated fullerene, solvents capable of dissolving the hydrogenated fullerene as the reaction product or solvents incapable of dissolving the hydrogenated fullerene may be selectively used according to the purification methods. Here, the term “dissolving” means that a solubility in the solvent is not less than 1 mg/mL.

The solvent capable of dissolving fullerene or the hydrogenated fullerene are preferably aromatic hydrocarbons from the standpoint of high solubility or high affinity. The aromatic hydrocarbons may have substituent groups, e.g., alkyl groups such as methyl group and ethyl group, halogen atoms such as chlorine atom and bromine atom, a hydroxyl group or the like. Examples of the aromatic hydrocarbons may include non-halogenated aromatic hydrocarbons such as benzene, toluene, xylenes and trimethylbenzenes, and halogenated aromatic hydrocarbons such as chlorobenzene, dichlorobenzenes, bromobenzene and dibromobenzenes. Of these aromatic hydrocarbons, from the standpoint of facilitated operation of distilling off the solvent, preferred are non-halogenated aromatic hydrocarbons, and more preferred is toluene. Examples of the solvents incapable of dissolving the hydrogenated fullerene may include aliphatic hydrocarbons such as pentane, hexane, heptane and octane, alcohols such as methanol and ethanol, or the like. The above-described reaction solvents are preferably deaerated before the use.

Among the solvent processes, the reduction process using Zn/hydrochloric acid is more advantageous than the other processes in the consideration of low costs as well as relatively high selectivity. Further, in the above reduction process, a hydrogen chloride gas may be flowed through the reaction solution instead of using hydrochloric acid, so that it is possible to conduct the reaction in a saturated aqueous hydrogen chloride solution (concentrated hydrochloric acid) continuously, resulting in increase in yield as well as reduction in content of the solvent relative to the raw fullerene.

The reduction process using hydrogen chloride instead of hydrochloric acid is explained in more detail below.

The solvent used in the reaction is not particularly limited as long as fullerenes can be reduced therein in the presence of metallic zinc.

Also, the ratio between the raw fullerene and the solvent used in the reaction may be optional. However, since the use of a too large amount of the solvent is economically disadvantageous, the concentration of the raw fullerene based on the solvent is preferably not less than 1 g/L. On the other hand, when the amount of the solvent used is too small, a large additional amount of the solvent tends to be required upon the extraction of the reaction product owing to its solubility, so that the advantage of a high ratio of the raw fullerene to the solvent used in the reaction is substantially lost. Therefore, the concentration of the raw fullerene based on the solvent used in the reaction is preferably in the range of not less than 10 g/L and not more than 15 g/L.

In the process of the present invention, in order to suitably conduct the reduction reaction, in addition to the solvent capable of dissolving the raw fullerene, water is preferably further added to the reaction system, thereby conducting the reaction in a two phase system composed of the aromatic hydrocarbon and water. The ratio (volume ratio) of water to the aromatic hydrocarbon is usually not less than 0.05, preferably not less than 0.1, and usually not more than 0.4, preferably not more than 0.3. Therefore, the suitable combined range of the volume ratio is usually from 0.05 to 0.4, preferably from 0.1 to 0.3. When the amount of water added is too small, the reaction may fail to proceed sufficiently. When the amount of water added is too large, the reaction efficiency based on a reaction vessel used tends to be deteriorated.

Zinc used in the process of the present invention may have any suitable shape such as granule and powder. Among them, zinc powder is preferred from the standpoint of good dispersion. The molar ratio of zinc to fullerene is usually not less than 150, preferably not less than 200, and usually not more than 500, preferably not more than 400. Therefore, the suitable combined range of the molar ratio is usually from 150 to 500, preferably from 200 to 400. When the amount of zinc used is too small, the reaction may fail to proceed sufficiently, resulting in only production of the hydrogenated fullerene with a low hydrogen content. When the amount of zinc used is too large there tend to arise not only economical disadvantage but also increase in amount of waste zinc to be disposed of.

The hydrogen chloride gas is preferably flowed through the reaction solution in an amount of not less than two moles based on one mole of zinc used in the reaction. When the amount of the hydrogen chloride gas flowed through the reaction solution is too small, the reaction may fail to proceed sufficiently, and there tend to arise problems such as poor yield. Also, the hydrogen chloride gas is preferably fed from an underside of the reaction solution. In addition, the hydrogen chloride gas is preferably flowed during the whole period of the reaction, but may be flowed intermittently.

The reaction temperature in the present invention upon producing the hydrogenated fullerene while flowing the hydrogen chloride gas through the reaction solution in the presence of zinc is usually not less than 20° C., preferably not less than 50° C., more preferably not less than 70° C., and usually not more than 120° C., preferably not more than 100° C., more preferably not more than 90° C. Therefore, the suitable combined range of the reaction temperature is usually from 20 to 120° C., preferably from 50 to 100° C., more preferably from 70 to 90° C. Since the reaction temperature usually reaches about 80° C. only by the exothermic heat of reaction, any external heating source is not required. However, the temperature of the reaction solution may be controlled by the external heating source.

Further, since the reaction of the present invention is in the form of a heterogeneous reaction, the reaction is preferably conducted under stirring. The stirring method is not particularly limited as long as the raw materials, etc., are sufficiently dispersed in the reaction system.

After completion of the reaction according to the present invention, the reaction product may be successively subjected to extraction, washing with water, an aqueous alkaline solution, etc., and then drying. At this time, since the reaction product is unstable in air, all of steps in the process are preferably conducted in an inert gas atmosphere. Specific examples of the inert gas may include rare gases such as argon and helium, nitrogen, etc.

The hydrogenated fullerene produced by the above process is a molecule formed by introducing hydrogen atoms into fullerene. When C₆₀ is used as the raw fullerene, the resultant hydrogenated fullerene is in the form of a hydride containing C₆₀H₃₆ as a main component, whereas when C₇₀ is used as the raw fullerene, the resultant hydrogenated fullerene is in the form of a hydride containing C₇₀H₃₆/₃₈ as a main component. Both the reaction products are a mixture of hydrogenated fullerenes having various hydrogen contents. Meanwhile, C₇₀H₃₆/₃₈ means such a mixture with a molecular weight distribution which contains C₇₀H₃₆ and C₇₀H₃₈ both having 70 carbon atoms as main components.

In various production processes as mentioned above, the hydrogenated fullerene represented by the general formula: CₙHₘ, wherein n is an integer of not less than 60 and m is an integer of 2 to 44, is mainly produced. The degree of hydrogenation (m) of the hydrogenated fullerene to the raw fullerene may be determined by a mass spectrometric (MS) analysis in the case of a single hydrogenated product, and may be determined as an average hydrogen content by elemental analysis in the case of a mixture of a plurality of hydrogenated products. Although the hydrogenation ratio (m) in the respective hydrogenated products produced in the present invention is not particularly limited, when C₆₀ is used as the raw fullerene, preferred hydrogenated products are C₆₀H₂, C₆₀H₁₈ and C₆₀H₃₆, and when C₇₀ is used as the raw fullerene, preferred hydrogenated products are C₇₀H₃₆ and C₇₀H₃₈. Among them, most preferred hydrogenated products are C₆₀H₃₆ and C₇₀H₃₈ since these hydrogenated products can be selectively synthesized. The hydrogenated fullerene produced by the above reduction method may be sometimes in the form of not a pure product but a mixture of plural kinds of hydrogenated products. In such a case, preferred is the mixture containing C₆₀H₃₆ or C₇₀H₃₈ as a main component. In addition, the mixture preferably has a composition composed of C₆₀H₃₀ to C₆₀H₄₀ or C₇₀H₃₀ to C₇₀H₄₄, namely those hydrogenated products represented by the general formula: CₙHₘ wherein m is 30 to 44.

The hydrogenated fullerene, in particular, such a hydrogenated fullerene synthesized without using a solvent, is preferably subjected to purification treatments such as washing with a solvent, crystallization and chromatographic separation in order to remove by-products, impurities such as unreacted raw materials, etc. For example, in the method described in “Angew. Chem. Int. Ed. Engl.”, 1993, Vol. 32, p. 584, it is considered that by-products such as anthracene or reagents such as dihydroanthracene are removed by washing.

The thus produced hydrogenated fullerene may contain the solvent used upon the hydrogenation reaction of fullerene and the purification of the resultant hydrogenated fullerene, in an amount of usually about 3 to 15% by weight.

According to the present invention, the solvent-containing hydrogenated fullerene produced by the above method is heat-treated to remove the solvent therefrom until the solvent content therein is lessened to not more than 2% by weight.

The solvent content in the hydrogenated fullerene, i.e., the percentage of the solvent based on the total amount of the solvent and the hydrogenated fullerene, is preferably not more than 0.5% by weight, more preferably not more than 0.3% by weight, still more preferably not more than 0.2% by weight, most preferably not more than 0.05% by weight. The solvent content in the hydrogenated fullerene is preferably as low as possible.

Meanwhile, in the present invention, the solvent content in the hydrogenated fullerene is determined as the value measured by gas chromatography. More specifically, the solvent content in the hydrogenated fullerene may be measured by the following method.

That is, a 6 mL vial with a septum is charged with about 10 mg of the hydrogenated fullerene and 4.0 g of N-methylpyrrolidone as weighed, and the contents of the vial are subjected to ultrasonic irradiation for 5 min. Then, the gas phase portion of the vial is extracted for 20 min using a solid phase micro-extraction (SPME) fiber produced by Spelco Inc., while heating the contents thereof to 60° C. The thus extracted sample is introduced into a gas chromatographic apparatus through the SPME fiber to determine an area ratio of the solvent to N-methylpyrrolidone. Separately, a mixed solution composed of the solvent to be measured and N-methylpyrrolidone is measured to obtain several area ratio values thereof, thereby preparing a calibration curve thereof. Using the thus prepared calibration curve, the amount of residual solvent in the sample is calculated. From the thus calculated amount of the solvent and the weight of the sample used, the solvent content based on the total amount of the solvent and the hydrogenated fullerene is determined.

The heating temperature used upon removing the solvent by distillation may be appropriately selected depending upon the method for production of the hydrogenated fullerene, the hydrogen content of the hydrogenated fullerene and kind and amount of the solvent contained therein. The heating temperature is usually higher by not less than 30° C., preferably not less than 50° C., more preferably not less than 100° C., than a boiling point of the solvent contained in the hydrogenated fullerene. Specifically, the heating temperature is usually not less than 130° C., preferably not less than 180° C., more preferably not less than 200° C., still more preferably not less than 230° C., most preferably not less than 250° C. When the heating temperature is too low, it may be difficult to remove the solvent sufficiently, thereby failing to attain a sufficient effect of stabilizing the hydrogenated fullerene. On the other hand, when the heating temperature is too high, the hydrogenated fullerene itself tends to be decomposed. Therefore, the heating temperature is usually not more than 400° C.

Further, the heating procedure is preferably conducted in an inert gas atmosphere such as argon and helium, more preferably under the inert gas flow. In particular, when the heating procedure is conducted in a gas atmosphere containing oxygen, the hydrogenated fullerene tends to undergo oxidation reaction or change in its skeleton upon heating. Therefore, it is required that the heating procedure is conducted in a gas atmosphere containing substantially no oxygen.

Although the heating procedure may be conducted under any pressure condition, in order to conduct the heat treatment under a strict oxygen-free condition, the heat treatment is preferably conducted under ordinary pressure while flowing the inert gas.

The heating time may vary depending upon kind and amount of the solvent contained in the hydrogenated fullerene as well as kind of the hydrogenated fullerene as produced. The heating time is usually from about several minutes to about one day, preferably from about 0.5 hour to about 12 hours.

The hydrogenated fullerene whose solvent content is lessened by heating is such an oxidation-resisting hydrogenated fullerene which exhibits an extremely low oxidative deterioration even upon storing under an oxygen-containing gas atmosphere such as air. The oxidation-resisting hydrogenated fullerene is kept in a stable state in air and, therefore, can be stably stored for a long period of time.

The oxidation-resisting hydrogenated fullerene of the present invention means a hydrogenated fullerene, in which the number of oxygen atoms introduced per one fullerene skeleton is not more then 2 when measured by the elemental analysis after allowing the hydrogenated fullerene to stand usually at room temperature, specifically at a temperature of 15 to 30° C. in air for 10 days.

In addition, although the hydrogenated fullerene is soluble in aromatic hydrocarbons such as toluene, the oxidized hydrogenated fullerene becomes insoluble in the aromatic hydrocarbon solvent. Therefore, by examining the solubility of the hydrogenated fullerene in the aromatic hydrocarbon solvent, it can be readily determined whether or not the hydrogenated fullerene still exhibits a suitable oxidation resistance. More specifically, the hydrogenated fullerene having a sufficient stability in air is a hydrogenated fullerene which is still soluble in toluene even after allowing it to stand in air at room temperature for 10 days. Meanwhile, the oxidized product of the hydrogenated fullerene, which is insoluble in the aromatic hydrocarbon solvent is soluble in a polar solvent such as dimethyl sulfoxide. Here, the term “soluble” means that the solubility of the hydrogenated fullerene in the solvent is not less than 1 mg/mL.

The degree of oxidation of the hydrogenated fullerene may be determined by the above method of examining the solubility in toluene as well as the method of measuring the content of oxygen atoms by elemental analysis, a method of confirming whether any absorption corresponding to the C—O bond as observed near 1000 cm⁻¹ in infrared absorption spectra (IR) thereof is present or not, or the like.

The reason why the hydrogenated fullerene containing a less solvent content as produced by the process of the present invention can be prevented from undergoing the oxidative deterioration, is considered as follows, though it is not clearly determined. That is, according to X-ray crystallographic analysis, since the degree of the crystallinity of the hydrogenated fullerene is increased by removing the solvent therefrom, it is suggested that the hydrogenated fullerene containing the solvent is insufficient in crystallization and, therefore, has a large surface area, thereby causing the hydrogenated fullerene to be susceptible to oxidation. Further, it is also considered that the solvent incorporated into the hydrogenated fullerene is directly concerned in the oxidation reaction.

### EXAMPLES

The present invention is described in more detail by Examples, but the Examples are only illustrative and not intended to limit the scope of the present invention.

Meanwhile, various properties were measured by the following methods.

Measurement of Infrared Absorption Spectrum (IR):

The infrared absorption spectrum was measured by a diffused reflection method using an apparatus “NEXUS670” manufactured by Nicolet Inc., which was purged with nitrogen, at a number of accumulation of 64 times and a resolution performance of 4 cm⁻¹. A sample for the IR measurement was prepared by diluting 0.5 mg of the hydrogenated fullerene with about 50 mg of KBr powder. As a control sample, there was used the KBr powder.

Differential Thermal Analysis (TG-DTA):

The differential thermal analysis was conducted in a nitrogen atmosphere at a temperature rise rate of 10° C./min using “TG-DTA 2000” manufactured by MAC SCIENCE Inc.

Elemental Analysis:

Carbon, hydrogen and nitrogen were analyzed using “PE2400 Series II CHNS/O Analyzer” manufactured by PERKIN ELMER Co., Ltd., whereas oxygen was analyzed using an oxygen/nitrogen analyzer “TC-436” manufactured by LECO Inc.

Measurement of Solvent Content:

The solvent content in the hydrogenated fullerene was measured by the following method. That is, a 6 mL vial with a septum was charged with 10 mg of the hydrogenated fullerene and 4.0 g of N-methylpyrrolidone as weighed, and the contents of the vial were subjected to ultrasonic irradiation. Thereafter, the gas phase portion of the vial was extracted for 20 min using a solid phase micro-extraction (SPME) fiber produced by Spelco Inc., while heating the contents thereof to 60° C. The thus extracted sample was introduced into a gas chromatographic (GC) apparatus through the SPME fiber to determine an area ratio of the solvent to N-methylpyrrolidone. Separately, a mixed solution composed of the solvent to be measured and N-methylpyrrolidone was measured to obtain several area ratio values thereof, thereby preparing a calibration curve thereof. Using the thus prepared calibration curve, the amount of the solvent in the hydrogenated fullerene was calculated.

### Synthesis Example 1

### Synthesis of Hydrogenated Fullerene A

The following synthesis was conducted by referring to “Journal of the Chemical Society: Perkin Transaction 2”, 1995, p. 2359.

A 2 L flask whose inside was purged with nitrogen was charged with 1 g of C₆₀, and then the inside of the flask was further purged with nitrogen. Then, 900 mL of toluene (having a boiling point of 110.6° C.) was added into the flask, and the contents of the flask were stirred to obtain a violet homogeneous solution. The thus obtained solution was mixed with 50 g of zinc powder, and then 150 mL of concentrated hydrochloric acid was dropped into the resultant mixture for 10 min while vigorously stirring. After completion of the dropping, the resultant reaction mixture was further stirred for one hour.

After completion of the stirring, the obtained solution was allowed to stand and separate into two layers, and the toluene solution as the upper layer was withdrawn. The thus obtained toluene solution was washed with 50 mL of deionized water one time, with 50 mL of a saturated NaHCO₃ aqueous solution twice, and then with 50 mL of water one time, and then dried by adding anhydrous magnesium sulfate thereto. The thus washed and dried toluene solution was filtered through cerite. The obtained filtrate was concentrated under reduced pressure at room temperature using an evaporator, thereby obtaining a light yellow solid.

The thus obtained light yellow solid and deaerated n-hexane (having a boiling point of 68.7° C.) were charged into a vial, stirred to form a slurry, and then allowed to stand. After withdrawing hexane as a supernatant, a nitrogen gas was flowed through the vial at room temperature to remove the solvent therefrom, thereby obtaining 600 mg of light yellow powder (hydrogenated fullerene A).

As a result, it was confirmed that the resultant hydrogenated fullerene A had such a solvent content that the toluene and hexane contents therein were 8.0% by weight and 2.9% by weight, respectively, and the solubility of the hydrogenated fullerene A in toluene was not less than 1 mg/mL.

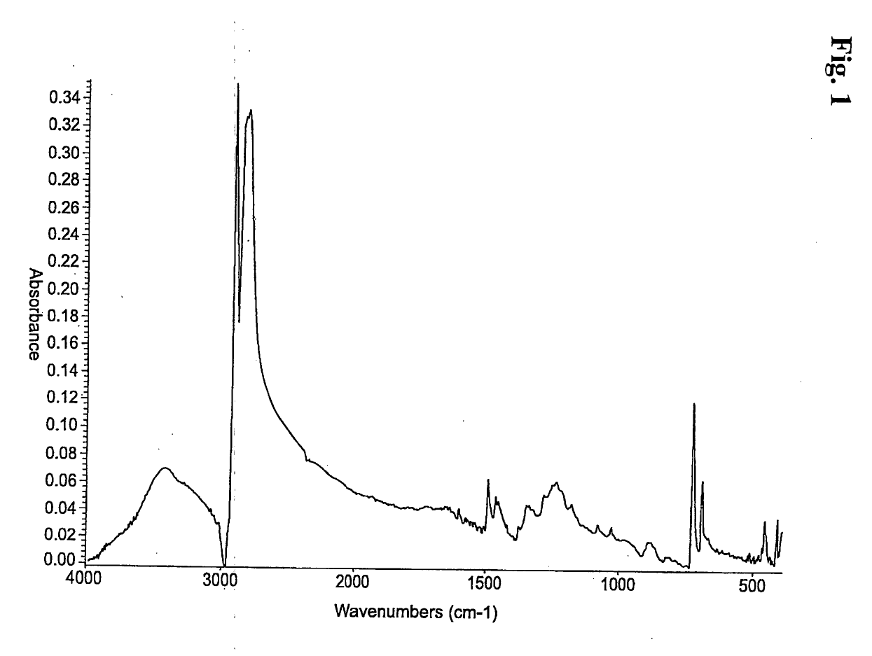

The results of IR measurement of the hydrogenated fullerene A are shown in FIG. 1. From FIG. 1, it was confirmed that the specific peak due to C—H stretching vibration was detected at 2900 cm^{-1.}

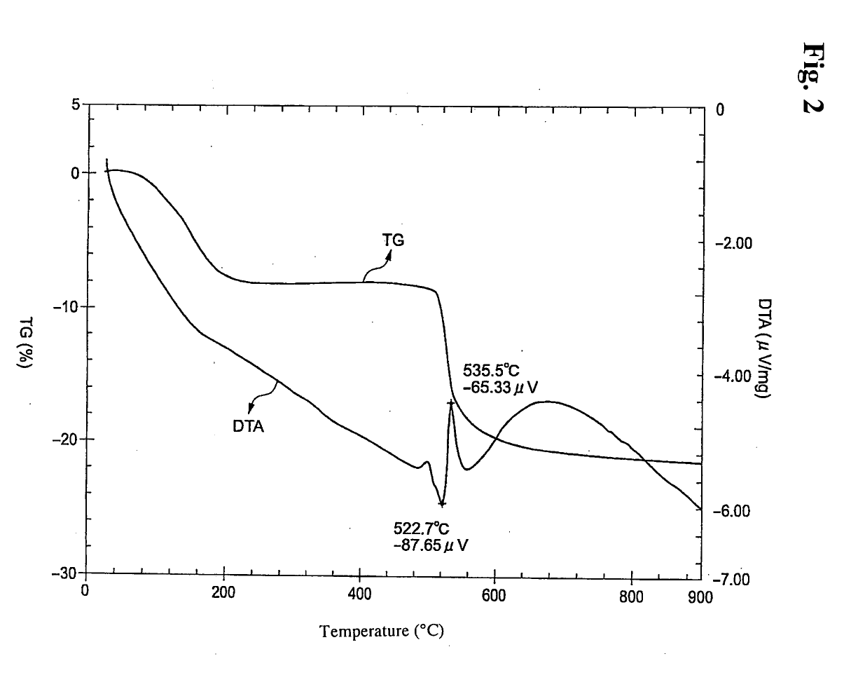

Also, the results of the TG-DTA measurement of the hydrogenated fullerene A (14.800 mg) are shown in FIG. 2. From FIG. 2, it was confirmed that the weight loss which was considered to be due to vaporization of the solvent was observed at a temperature of not more than 200° C., and the weight loss which was considered to be due to decomposition of the hydrogenated fullerene was observed at a temperature of not less than 500° C. Further, from the fact that the weight loss was continued even in a temperature range not less than boiling points of toluene and hexane, it was considered that the solvent was incorporated into powder of the reaction product by the specific interaction therebetween.

Further, as a result of the elemental analysis, it was confirmed that the hydrogenated fullerene A had a composition of C₆₀H₃₄+₃.

### Synthesis Example 2

### Synthesis of Hydrogenated Fullerene B

The following synthesis was conducted by referring to Japanese Patent No. 3066495.

A 200 mL autoclave was charged with a solution containing 100 mg of C₆₀ and 100 mL of deaerated toluene and a catalyst prepared by nickel supported on alumina baked at 450° C. for 3 hours under a hydrogen flow (Ni content: 10% by weight). An inside of the autoclave was replaced with hydrogen, and then pressurized to 5 MPa by a hydrogen gas. After raising an internal temperature of the autoclave from room temperature to 150° C. for 40 min, the contents of the autoclave were stirred at 150° C. and 5 MPa for 30 min. The thus obtained solution was filtered through cerite to remove the catalyst therefrom, and then the solvent was distilled away therefrom, thereby obtaining 92.8 mg of a yellow solid (hydrogenated fullerene B).

As a result, it was confirmed that the resultant hydrogenated fullerene B had such a solvent content that the toluene content thereof was 5.83% by weight, and the solubility of the hydrogenated fullerene B in toluene was not less than 1 mg/mL.

### Synthesis Example 3

### Synthesis of Hydrogenated Fullerene C

The same procedure as defined in Synthesis Example 1 was conducted except that C₇₀ was used as the raw material instead of C₆₀, and 500 mg of C₇₀, 25 g of zinc powder and 75 mL of concentrated hydrochloric acid were used, thereby obtaining 260 mg of a hydrogenated product of C₇₀ (hydrogenated fullerene C).

As a result, it was confirmed that the resultant hydrogenated fullerene C had such a solvent content that the toluene and hexane contents therein were 0.4% by weight and 5.46% by weight, respectively, and the solubility of the hydrogenated fullerene C in toluene was not less than 1 mg/mL.

Further, as a result of the elemental analysis, it was confirmed that the hydrogenated fullerene C had a composition of C₇₀H_{40±3}.

### Example 1

200 mg of the hydrogenated fullerene A was charged into a vial, heat-treated at 250° C. for 2 hours under a nitrogen gas flow, and then allowed to stand under the nitrogen gas flow for cooling, thereby obtaining an oxidation-resisting hydrogenated fullerene in the form of a light yellow solid.

As a result of the measurement of a solvent content of the thus obtained oxidation-resisting hydrogenated fullerene, it was confirmed that the toluene and hexane contents therein both were below the detection limits, i.e., not more than 0.007% by weight and not more than 0.004% by weight, respectively. Also, as a result of the gas chromatographic analysis, no peaks corresponding to solvents other than toluene and hexane were observed. From these facts, it was recognized that the oxidation-resisting hydrogenated fullerene contained substantially no solvent.

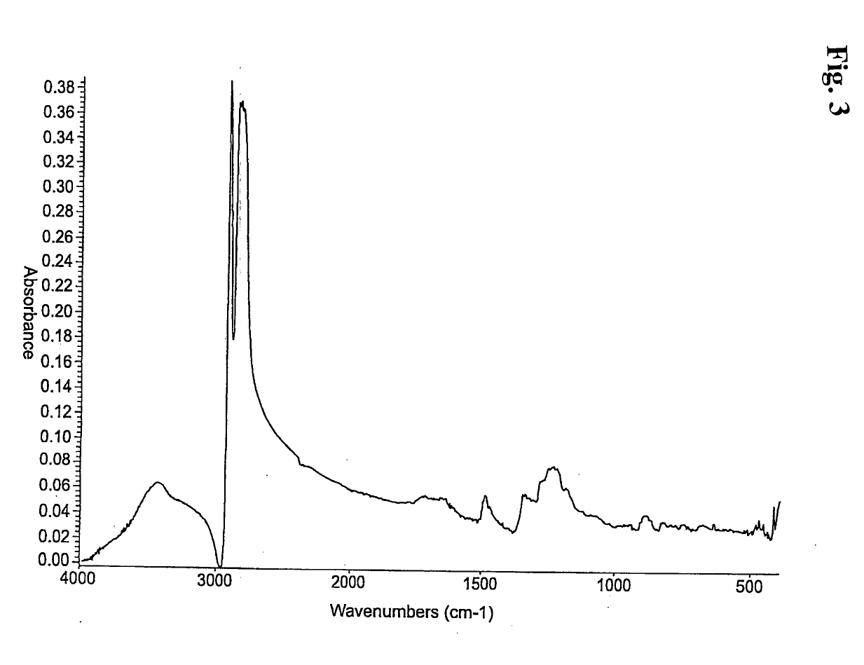

The results of the IR measurement of the thus obtained oxidation-resisting hydrogenated fullerene are shown in FIG. 3. From the comparison between FIGS. 3 and 1, it was confirmed that although FIG. 3 was largely different from FIG. 1 in that the sharp peaks observed in FIG. 1 near 690 cm⁻¹ and 720 cm⁻¹ corresponding to toluene were no longer detected in FIG. 3, the others of the absorption patterns shown in FIGS. 3 and 1 were substantially identical to each other.

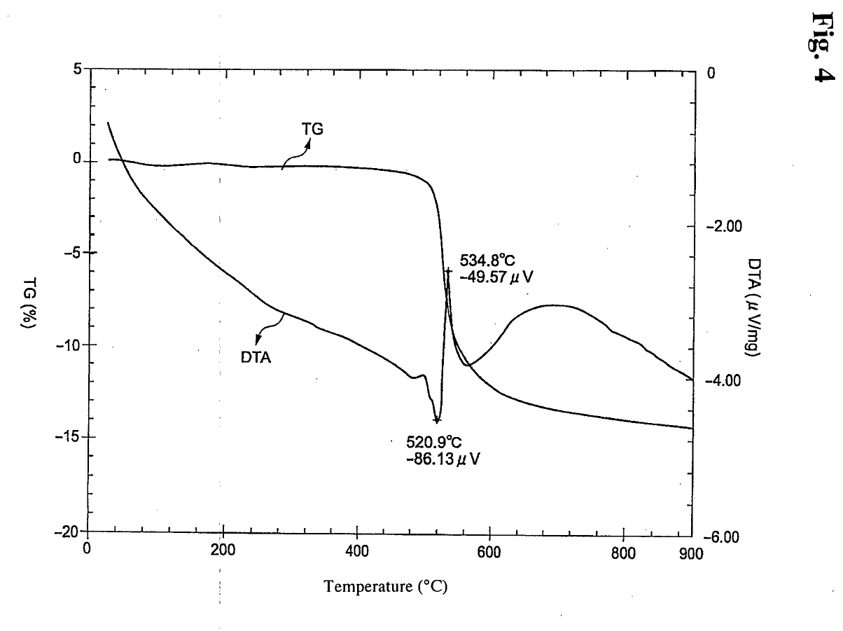

The results of the TG-DTA measurement of the oxidation-resisting hydrogenated fullerene are shown in FIG. 4. From the comparison between FIGS. 4 and 2, it was confirmed that the weight loss due to vaporization of the solvent at a temperature of not more than 200° C. as observed in FIG. 2 was no longer recognized in FIG. 4, but the weight loss due to decomposition of the hydrogenated fullerene was observed near 500° C. similarly to FIG. 2.

The thus obtained oxidation-resisting hydrogenated fullerene was allowed to stand in air at room temperature, and sampled after the elapse of 10 days, 20 days and 30 days to visually observe a solubility of the samples in toluene and measure the oxygen contents thereof by the elemental analysis. The results are shown in Table 1.

From the results, it was confirmed that the hydrogenated fullerene sampled even after 30 days underwent not remarkable but slight oxidation, still maintained a good solubility in toluene even after 30 days and, therefore, was stable in air.

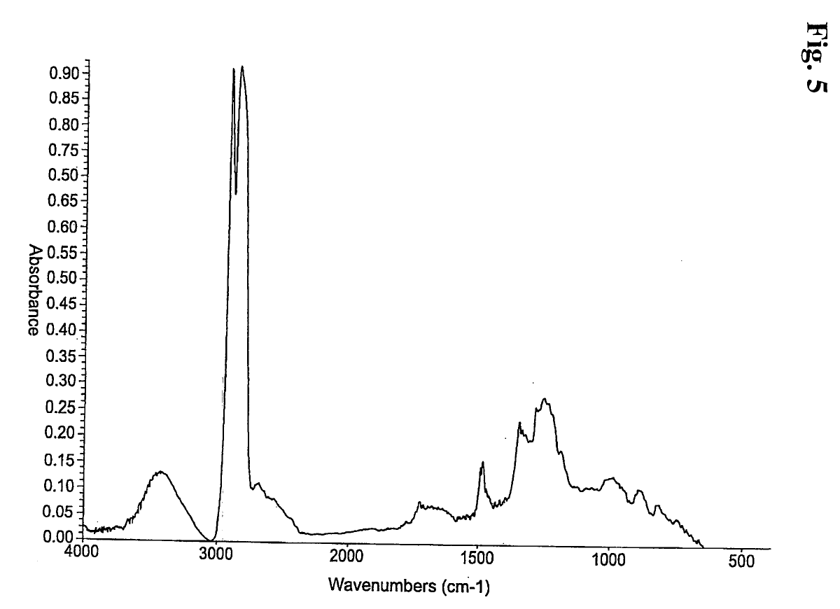

Further, the results of the IR measurement of the oxidation-resisting hydrogenated fullerene sampled after the elapse of 30 days are shown in FIG. 5. From FIG. 5, it was confirmed that the peak attributed to an extremely small C—O stretching vibration was detected near 1000 cm^{-1.}

### Example 2

50 mg of the hydrogenated fullerene A was charged into a vial, heat-treated at 200° C. for 2 hours under a nitrogen gas flow, and then allowed to stand under the nitrogen gas flow for cooling, thereby obtaining an oxidation-resisting hydrogenated fullerene in the form of a light yellow solid.

As a result of the measurement of a solvent content of the thus obtained oxidation-resisting hydrogenated fullerene, it was confirmed that the toluene and hexane contents therein were 0.23% by weight and 0.05% by weight, respectively. Also, as a result of the gas chromatographic analysis, no peaks corresponding to solvents other than toluene and hexane were observed.

Further, although the oxidation-resisting hydrogenated fullerene was further heat-treated at 200° C. for 4 hours, no reduction in solvent content was observed.

### Example 3

The same procedure as defined in Example 2 was conducted except that the heating temperature was changed to 150° C., thereby obtaining an oxidation-resisting hydrogenated fullerene in the form of a light yellow solid.

As a result of the measurement of a solvent content of the thus obtained oxidation-resisting hydrogenated fullerene, it was confirmed that the toluene and hexane contents therein were 0.50% by weight and 0.13% by weight, respectively. Also, as a result of the gas chromatographic analysis, no peaks corresponding to solvents other than toluene and hexane were observed.

### Comparative Example 1

The same procedure as defined in Example 1 was conducted except that the heating temperature was changed to 100° C., thereby obtaining a light yellow solid.

As a result of the measurement of a solvent content of the thus obtained light yellow solid, it was confirmed that the toluene and hexane contents therein were 2.9% by weight and 0.9% by weight, respectively. Also, as a result of the gas chromatographic analysis, no peaks corresponding to solvents other than toluene and hexane were observed.

The thus obtained light yellow solid was allowed to stand in air at room temperature, and sampled after the elapse of 10 days, 20 days and 30 days to visually observe a solubility of the samples in toluene and measure the oxygen contents thereof by the elemental analysis. The results are shown in Table 1. From the results, it was confirmed that since the sampled solid underwent significant oxidation in air by oxygen contained therein for 10 days, the solubility of the sampled solid in toluene was considerably deteriorated. Therefore, it was recognized that the sample was unstable in air.

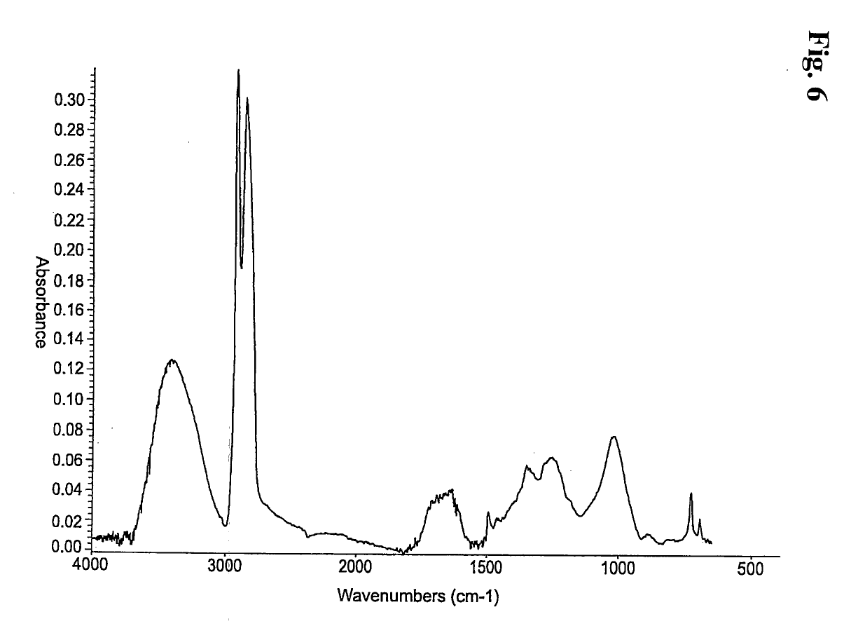

Further, the results of the IR measurement of the solid sampled after the elapse of 30 days are shown in FIG. 6. From FIG. 6, it was confirmed that the peak which was considered to correspond to C—O stretching vibration near 1000 cm⁻¹ was large as compared to that of FIG. 5, and further a slight peak which was considered to correspond to C═O stretching vibration was observed near 1700 cm⁻¹. In addition, in FIG. 6, it was also confirmed that the peak which was considered to correspond to O—H stretching vibration was detected near 3300 cm⁻¹ as a relatively large peak as compared to that of FIG. 5.

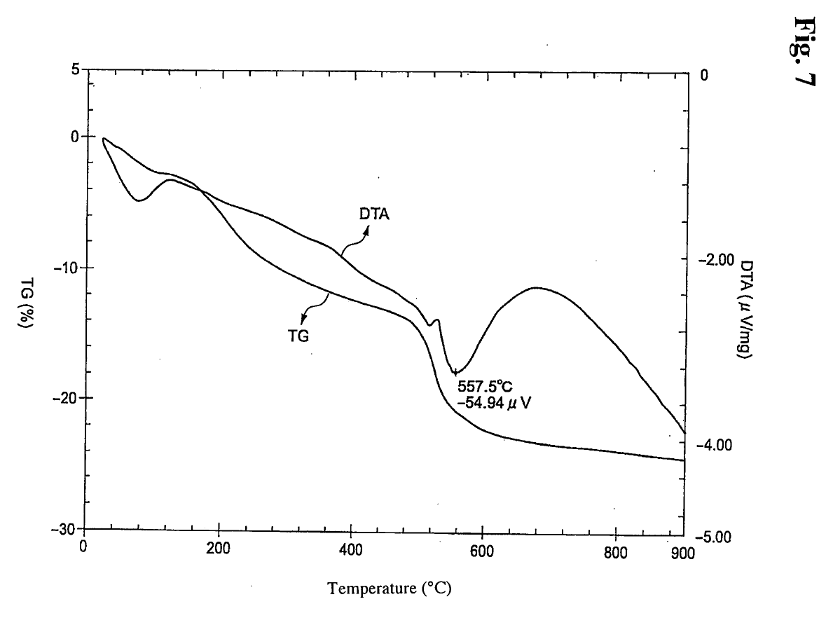

The results of the TG-DTA measurement of the light yellow solid (16.848 mg) sampled after the elapse of 30 days are shown in FIG. 7. In FIG. 7, a moderate weight loss which was not observed in FIGS. 2 and 4 and was considered to be attributed to the decomposition reaction was detected at a temperature of from near 150° C. to near 450° C. It was suggested that the weight loss was caused by any decomposition reaction generated at oxidized sites.

### Comparative Example 2

100 mg of the hydrogenated fullerene A was dissolved in 20 mL of toluene to prepare a homogeneous solution. The resultant solution was allowed to stand in air at room temperature. As a result, the solution became turbid within one hour. The resultant solution was continuously allowed to stand in air at room temperature and then sampled after the elapse of 3 days, 10 days, 20 days and 40 days. The respective samples were subjected to distillation to remove the solvent therefrom, thereby obtaining powder. Then, the obtained powder were subjected to elemental analysis and GC to measure a residual solvent content therein. Based on these measurement results, the oxygen content in the hydrogenated fullerene was calculated.

In addition, the powder were visually observed to determine a solubility thereof in toluene. The results are shown in Table 1. Form the results, it was confirmed that the powder obtained from the solution sampled even after 3 days suffered from severe oxidation and, therefore, the hydrogenated fullerene in the solvent was extremely unstable in air.

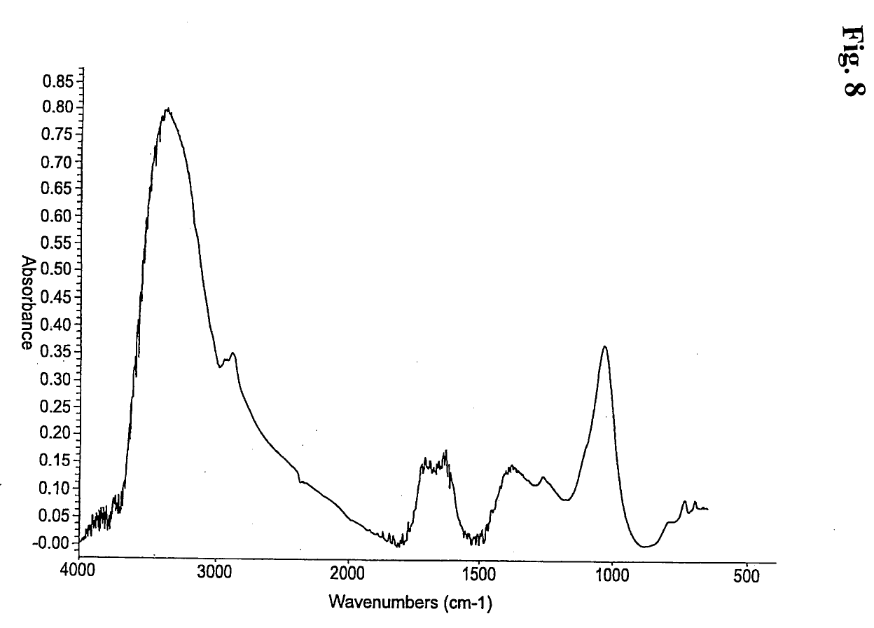

Further, the IR chart of the powder obtained from the solution sampled after 40 days is shown in FIG. 8. In FIG. 8, it was confirmed that the peak corresponding to C—H stretching vibration as observed near 2900 cm⁻¹ was extremely small, whereas the peak corresponding to C—O stretching vibration as observed near 1000 cm⁻¹ and the peak corresponding to O—H stretching vibration as observed near 3300 cm⁻¹ were very large and the peak as observed near 1700 cm⁻¹ was relatively large as compared to that of FIG. 5.

### Comparative Example 3

The hydrogenated fullerene A was heat-treated at 600° C. under a nitrogen gas flow for 3 hours, so that black powder were produced. It was suggested that the hydrogenated fullerene underwent decomposition reaction.

### Example 4

The hydrogenated fullerene B was heat-treated at 250° C. under a nitrogen gas flow for 2 hours, thereby obtaining an oxidation-resisting hydrogenated fullerene. The thus obtained oxidation-resisting hydrogenated fullerene was stored in air at room temperature for 10 days. Thereafter, 1 mg of the hydrogenated fullerene was sampled, and 1 mL of toluene was added thereto. As a result, it was confirmed that the hydrogenated fullerene was homogeneously dissolved in toluene.

### Comparative Example 4

The hydrogenated fullerene B was stored in air at room temperature for 10 days. Thereafter, 1 mg of the hydrogenated fullerene was sampled, and 1 mL of toluene was added thereto. As a result, it was confirmed that the mixture was kept heterogeneous and, therefore, the hydrogenated fullerene was not dissolved in toluene.

### Example 5

The hydrogenated fullerene C was heat-treated at 250° C. under a nitrogen gas flow for 2 hours, thereby obtaining an oxidation-resisting hydrogenated fullerene. The thus obtained oxidation-resisting hydrogenated fullerene was stored in air at room temperature for 10 days. Thereafter, 1 mg of the hydrogenated fullerene was sampled, and 1 mL of toluene was added thereto. As a result, it was confirmed that the hydrogenated fullerene was homogeneously dissolved in toluene.

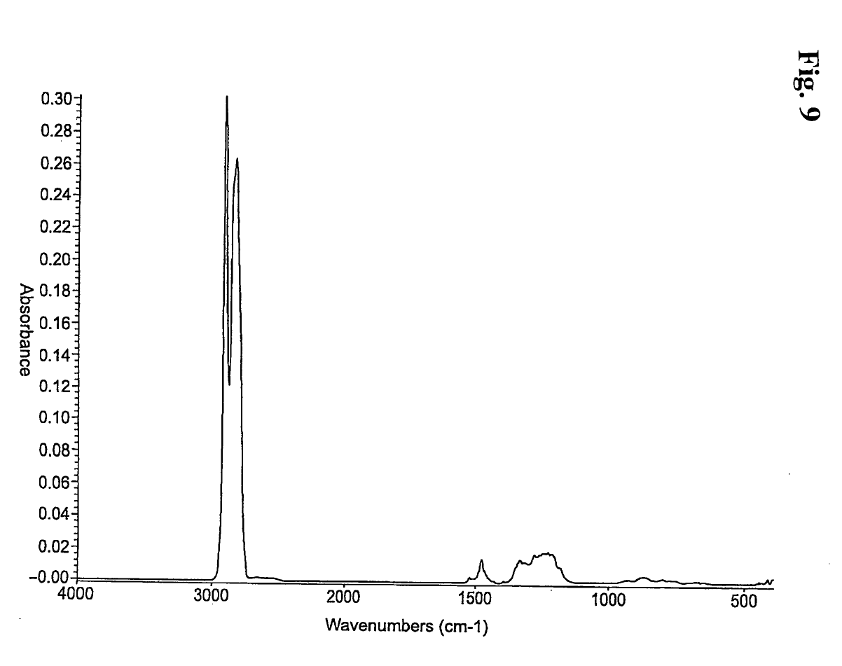

As a result of subjecting the oxidation-resisting hydrogenated fullerene stored in air at room temperature for 10 days to elemental analysis, it was confirmed that the oxygen content therein (O per C₇₀) was 0.83. The IR chart of the oxidation-resisting hydrogenated fullerene stored in air at room temperature for 10 days is shown in FIG. 9. In FIG. 9, the specific peak was detected at 2900 cm⁻¹ similarly to FIG. 3, whereas no peak was detected near 1000 cm^{-1.}

### Comparative Example 5

The hydrogenated fullerene C was stored in air at room temperature for 10 days. Thereafter, 1 mg of the hydrogenated fullerene was sampled, and 1 mL of toluene was added thereto. As a result, it was confirmed that the mixture was kept heterogeneous and, therefore, the hydrogenated fullerene was not dissolved in toluene.

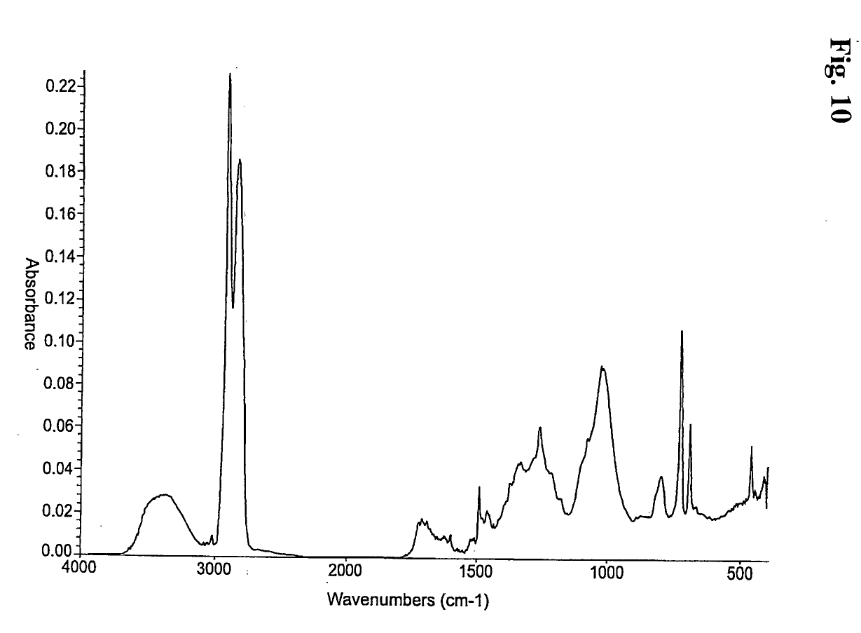

As a result of subjecting the hydrogenated fullerene C stored in air at room temperature for 10 days to elemental analysis, it was confirmed that the oxygen content therein (O per C₇₀) was 3.88. The IR chart of the hydrogenated fullerene C stored in air at room temperature for 10 days is shown in FIG. 10. In FIG. 10, similarly to FIG. 6, the peak which was considered to correspond to C—O stretching vibration near 1000 cm⁻¹, the peak which was considered to correspond to C═O stretching vibration near 1700 cm⁻¹, and the peak which was considered to correspond to O—H stretching vibration near 3300 cm⁻¹, were detected.

### Example 6

A 10 L five-necked glass flask equipped with a stirrer, a cooling tube, a thermometer and a hydrogen chloride gas blowing tube was charged with 5 L of toluene, and argon was bubbled therein to fully deaerate an inside thereof. Into the flask were successively added 70.0 g of C₆₀ (produced by Frontier Carbon Co., Ltd.; charging ratio of C₆₀ to toluene: 14 g/L), 2.1 kg of zinc and 1 L of deaerated deionized water. Then, while stirring the contents of the flask, 2.7 kg of a hydrogen chloride gas fed from a hydrogen chloride gas bomb was flowed into the flask through the blowing tube from the vicinity of a bottom of the flask for 3.6 hours to react the contents of the flask at a temperature of 82±3° C. After completion of flowing the hydrogen chloride gas, 0.7 L of deaerated deionized water was added into the flask to dilute a water phase therein, and then a toluene phase was separated therefrom. Further, the water phase was extracted with deaerated toluene three times in a total amount of 7 L. The thus obtained toluene phase was successively washed with deionized water and a saturated sodium hydrogencarbonate aqueous solution, and then dried with magnesium sulfate. The thus obtained product was filtered through cerite under a nitrogen atmosphere (eluting solvent: toluene), and then the solvent was removed by distillation under ordinary pressure, thereby obtaining a hydrogenated fullerene D. The thus obtained hydrogenated fullerene D was dried at a temperature of 230 to 240° C. under an argon atmosphere for 8 hours, thereby obtaining a cream-colored solid (oxidation-resisting hydrogenated fullerene). As a result of the measurement, it was confirmed that the toluene content in the obtained oxidation-resisting hydrogenated fullerene was 0.03% by weight.

The thus obtained reaction product (oxidation-resisting hydrogenated fullerene) exhibited absorption at 2906 cm⁻¹ and 2843 cm⁻¹ in infrared absorption spectra thereof. Therefore, it was confirmed that carbon-hydrogen bonds were present in the hydrogenated fullerene. Further, 0.1 g of the oxidation-resisting hydrogenated fullerene was allowed to stand in air at room temperature for 32 days, and then visually observed to examine a solubility thereof in toluene. As a result, it was confirmed that the oxidation-resisting hydrogenated fullerene was dissolved in toluene.

TABLE 1

| | | standing days | | | | |
|---|---|---|---|---|---|---|
| | | 3 | 10 | 20 | 30 | 40 |
| Example 1 | Oxygen number | — | 0.36 | 0.53 | 1.29 | — |
| | per C₆₀ | | | | | |
| | Solubility in | — | ◯ | ◯ | ◯ | — |
| | toluene | | | | | |
| Comparative | Oxygen number | — | 2.74 | 3.76 | 5.11 | — |
| Example 1 | per C₆₀ | | | | | |
| | Solubility in | — | x | x | x | — |
| | toluene | | | | | |
| Comparative | Oxygen number | 12.56 | 14.78 | 16.75 | — | 20.3 |
| Example 2 | per C₆₀ | | | | | |
| | Solubility in | x | x | x | — | x |
| | toluene | | | | | |

In “Solubility in toluene” of Table 1, “◯” means that 1 mg of the sample was homogeneously dissolved in 1 mL of toluene at room temperature, and “x” means that 1 mg of the sample in 1 mL of toluene was kept in a heterogeneous state at room temperature.

### INDUSTRIAL APPLICABILITY

According to the process of the present invention, there can be produced a hydrogenated fullerene having a less solvent content. The obtained hydrogenated fullerene exhibits a high stability (oxidation resistance) in air and, therefore, can be suitably handled in air when applied to electronic materials, pigments for cosmetics, etc. Further, the hydrogenated fullerene of the present invention can be stored in air for a long period of time and, therefore, is extremely useful from industrial viewpoints.

1. A process for producing an oxidation-resisting hydrogenated fullerene, comprising heating a hydrogenated fullerene containing a solvent to remove the solvent therefrom until a solvent content in the hydrogenated fullerene is lessened to not more than 2% by weight.

2. A process according to claim 1, wherein the solvent is removed from the hydrogenated fullerene until the solvent content is lessened to not more than 0.3% by weight.

3. A process according to claim 1, wherein the hydrogenated fullerene is heated at a temperature higher by not less than 30° C. than a boiling point of the solvent contained therein.

4. A process according to claim 1, wherein the hydrogenated fullerene is heated at a temperature of 130 to 400° C.

5. A process according to claim 1, wherein the hydrogenated fullerene containing the solvent is produced by reducing fullerene while flowing a hydrogen chloride gas through a solution in the presence of metallic zinc.

6. A hydrogenated fullerene containing a solvent in an amount of not more than 2% by weight.

7. A hydrogenated fullerene according to claim 6, wherein a content of the solvent in the hydrogenated fullerene is not more than 0.3% by weight.

8. A hydrogenated fullerene produced by the process as defined in any of claims 1 to 5.

9. A hydrogenated fullerene for cosmetics as defined in any of claims 6 to 8.
